(19) United States
(12) Patent Application Publication
(10) Pub. No.: US 2003/0170341 A1
(43) Pub. Date: Sep. 11, 2003

(54) Arthropodicidal bait composition

(76) Inventors: Gerald Goodman, Miami, FL (US); Richard Ticktin, Ft. Lauderdale, FL (US)

Correspondence Address: BOZICEVIC, FIELD & FRANCIS LLP, 200 MIDDLEFIELD RD, SUITE 200, MENLO PARK, CA, 94025, US

(21) Appl. No.: 10/384,402

(22) Filed: Mar. 6, 2003

Related U.S. Application Data
(60) Provisional application No. 60/362,436, filed on Mar. 7, 2002.

(51) Int. Cl. A23L 1/00

(52) U.S. Cl. 426/1

(57) ABSTRACT

An insecticidal bait composition which is preferably an arthropodicidal bait composition is disclosed. The composition is preferably comprised of a transparent gelatin matrix material and an insect attractant dispersed in the matrix along with an insecticide or anthropodicidal composition. The insecticidal or anthropodicidal composition is preferably a borate, boric acid or derivative thereof such as disodium octoborate tetrahydrate dispersed in a transparent gelatin matrix material in an amount in a range of about 0.001 to about 5% by weight based on the total weight of the composition.

### CROSS-REFERENCE

This application claims the benefit of U.S. Provisional Application No. 60/362,436, filed Mar. 7, 2002, which application is incorporated herein by reference.

### FIELD OF THE INVENTION

This invention relates generally to arthropod bait materials and methods of utilizing the same. In particular, the arthropod bait materials and methods relate to arthropodicidal bait compositions in a gel form.

### BACKGROUND OF THE INVENTION

Arthropods, such as ants, cockroaches, termites, and silverfish are common household pests. Although a majority of arthropods are considered to be non-harmful nuisances, many can pose health risks or cause serious damage to structural wood and timber. Once established, many arthropods are very difficult to control. Homeowners frequently undertake control efforts by spraying numerous commercially available insecticides in areas where insects or other arthropods are observed. Professional pest control operators are also frequently contacted and the typical treatment procedure used by such professionals involves the application of insecticidal dusts or sprays around the infested structure or to a nest or hive, if it is able to be located. Effective control is hindered by difficulties in hive or nest location, and by the fact that many insect colonies often have multiple nests, utilizing numerous sites, both indoor and outdoor. When inspections fail to locate hives or nests, insecticides are usually applied to a number of different areas in and around a house. However, such practices are inefficient and typically ineffective.

A frequently better and safer alternative to eradicating arthropods in the home involves the use of insecticidal baits. In order to be effective, a bait must be targeted to the feeding preferences of the arthropod to be eradicated. Baits are advantageous in that they can be placed in foraging areas so that they can be consumed and transported back to the nest, thus eliminating the need to locate a nest or hive.

Many of the materials identified in the prior art are not attractive to ants or other arthropods. In order for a baited trap to be effective, the bait must attract the arthropods to be eradicated.

The prior art is replete with baits that are in liquid form. Thus, special procedures are required for the incorporation of the non-water soluble insecticide into the bait. Liquid baits have several drawbacks. For instance, liquid baits must be positioned out of trafficked areas since it is subject to spillage and may cause discoloration of floors, carpets, or other substrate. In addition, liquid baits evaporate over time, and, as a result of evaporative processes, the dissolved materials to become more concentrated over time. The physical change in the bait that occurs over time as a result of evaporation will detrimentally impact the efficacy and attractiveness of the bait. Moreover, by increasing the concentration of the toxicant in the bait through evaporation, the arthropod is killed too quickly and is unable to pass the toxin to hive or nest mates or lead other arthropods to the bait.

Bait stations are well known and many devices for holding a bait formulation having an attractant with a toxin to destroy arthropods, particularly crawling insects, have been disclosed. Three types of openings, one type being formed in the cover, the second type being formed in an extension mounted in the ground, and the third type being formed in an inner compartment control access to the toxin.

One disadvantage to the prior art bait stations is their complexity of design and higher manufacturing costs associated with forming intricate baffles and internal compartments to guide the insect and separate the bait from outside tampering. In addition, due to the design complexity, the insect entry openings to the bait were often limited, thereby reducing the efficacy of the bait station.

Another disadvantage to the prior art bait stations is typically that the bait and poison are permanently fixed in the bait station. Thus, when the bait is exhausted the station is rendered useless and cannot be replenished. Another disadvantage is that once the type of bait is chosen for the station, it often cannot be changed to suit changing insect populations or environmental conditions. Moreover, prior art bait stations, particularly those employing liquid baits, typically do not allow easy access in order to check the level or integrity of the bait. Yet another disadvantage, as stated above, is the rate of evaporation and level of interaction of the bait with the surrounding air and environment are not controlled. Therefore, the effectiveness and amount of bait in the station can be compromised from environmental factors such as heat, sunlight, wind, rain and moisture, or any other factor that will affect the bait.

Existing insecticidal consumer pressurized sprays rely on contact mode-of-action for mortality and may be repellant to the insect. Generally, the sprays are vaporized completely and thus affect only those insects that are contacted. Others may be deposited as a liquid on surface, however such deposits run on vertical or overhead surfaces, as well as on non-absorbent surfaces. Such liquid deposits will also be absorbed into permeable or porous surfaces such as wood or wallpaper. Thus these sprays will have relatively little residual activity.

Prior art pressurized spray gel bait allows delivery of non-repellent, longlasting insecticidal bait into structural cracks and voids that harbor insects, such as cockroaches. This requires that the composition be sufficiently fluent to be dispensed from a pressurized package, and be deposited in a form that will retain sufficient bulk to be ingested by cockroaches over a long period. However, these gels typically form a foam when dispensed. It has been found that although such foams are effective, they collapse to a thin film and this is not an ideal form for numerous arthropods to pick up with their mouthparts. Moreover, the prior art gels lack transparency and, as such, are unsightly in the home or business of the user.

Accordingly, a need exists for an arthropodicidal bait gel composition that is resistant to evaporative processes, does not foam during the dispensing process, and is transparent.

### SUMMARY OF THE INVENTION

The present invention eliminates the above-mentioned needs for an bait gel composition by providing an arthropodicidal bait gel composition and method for reducing an arthropod population.

In accordance with the present invention, there is provided an arthropodicidal bait composition comprising a gelatinous matrix material, an arthropod attractant dispersed in the gelatinous matrix material, and an arthropodicide dispersed in the gelatinous matrix material.

The present invention is further directed to an insecticidal bait composition comprising a gelatinous matrix material, an insect attractant dispersed in the gelatinous matrix material, and an insecticide dispersed in the gelatinous matrix material.

The present invention is still further directed to an insecticidal bait composition comprising a gelatinous matrix material, an insect attractant dispersed in the gelatinous matrix material, and a hydroscopic insecticide dispersed in the gelatinous matrix material.

The present invention is additionally directed to an insecticidal bait composition comprising a transparent gelatinous matrix material, an insect attractant dispersed in the transparent gelatinous matrix material, and a hydroscopic insecticide dispersed in the transparent gelatinous matrix material.

The present invention is additionally directed to an insecticidal bait composition comprising a transparent gelatinous matrix material, an insect attractant dispersed in the transparent gelatinous matrix material; and an effective amount of disodium octoborate tetrahydrate dispersed in the transparent gelatinous matrix material.

The present invention is additionally directed to a method for reducing an arthropod population, the method comprising the steps of placing a transparent gelatinous matrix material having an arthropod attractant and a hydroscopic arthropodicide dispersed in the transparent gelatinous matrix material under pressure in a container, dispensing said transparent gelatinous matrix material from the container, and depositing the transparent gelatinous matrix material on a substrate.

These and other objects, advantages, and features of the invention will become apparent to those persons skilled in the art upon reading the details of the bait composition, device and method as more fully described below.

### BRIEF DESCRIPTION OF THE DRAWINGS

FIG. 1 is an illustration of the preferred embodiment of the present invention in place in a corner.

FIG. 2 is an illustration of the present invention of FIG. 1 where the gel is shown stored in sealed flexible bag inside a pressurized container.

FIG. 3 is an illustration of the present invention where the gel is shown in a flexible bag inside a pressurized container different from the container of FIG. 2.

### DETAILED DESCRIPTION OF THE INVENTION

Before the present bait composition and methods are described, it is to be understood that this invention is not limited to particular compositions and methods described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, “the” include plural referents unless the context clearly dictates otherwise. Thus, for example, reference to “a matrix” includes a plurality of such matrix materials and reference to “the attractants” includes reference to one or more attractants and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

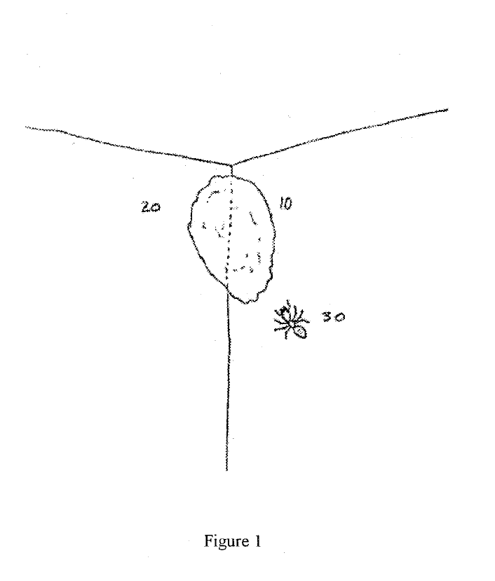

Referring now to FIG. 1, a preferred embodiment of the present invention is illustrated as arthropodicidal gel bait composition 10. Arthropodicidal gel bait composition 10 includes a gelatinous matrix material, an arthropod attractant dispersed in the gelatinous matrix material, and an arthropodicide dispersed in the gelatinous matrix material. Preferably, arthropodicidal gel bait composition 10 is an insecticidal bait composition comprising a transparent gelatinous matrix material, an insect attractant dispersed in the transparent gelatinous matrix material, and a hydroscopic insecticide dispersed in the transparent gelatinous matrix material. The insecticide can be selected from any one of a number of insecticides, including but not limited to borate, or boric acid derivatives, botanicals or natural organic compounds, chlorinated hydrocarbons, organophosphates, and carbamates. More preferably, the hydroscopic insecticide is an effective amount of disodiun octoborate tetrahydrate.

The boric acid or salts thereof and other insecticides listed above may be used alone or in combination with each other. Further, these insecticides may be used in combination with other arthropodicides including those disclosed within U.S. Pat. Nos. 4,849,450 issued Jul. 18, 1989; 5,571,830 issued Nov. 5, 1996; 4,320,142 issued Mar. 16, 1982 and 6,401,384 issued Jun. 11, 2002, all of which are incorporated herein in their entirety and specifically in order to disclose various insecticide and arthropodicidal compounds.

In addition, various bait compositions may be used alone or in combination with those of the present invention. Such compositions include those described within U.S. Pat. No. 6,245,327 issued Jun. 12, 2002 and U.S. Pat. No. 5,607,682 issued Mar. 4, 1997. In particular, the various gel compositions which include insect bait of the type disclosed within U.S. Pat. No. 5,238,681 issued Aug. 24, 1993 may be used in combination with the present invention. All of these patents are incorporated herein in their entirety and specifically in order to disclose bait compositions and gel formulations useful with the present invention.

As shown in FIG. 1, arthropodicidal gel bait composition 10 is applied to a substrate 20. Substrate 20 may include any substrate forming a surface or structural component of a building or other assembly. Due to the transparent nature of arthropodicidal gel bait composition 10, the resulting deposit is not unsightly. The transparent nature of arthropodicidal gel bait composition 10 allows users to deposit the composition on a variety of substrates, including doorways, ceilings, and corners without drawing unnecessary attention. If arthropodicidal gel bait composition 10 were to be pigmented in any way, it would be quite visible to the user or to those associated with the user. This would draw unnecessary attention to the presence of a pest problem or could be misinterpreted as another deficiency with the building, such as a water leak. Once deposited on substrate 20, arthropodicidal gel bait composition 10 remains intact until contacted by a foraging arthropod 30.

Foraging arthropod 30 contacts arthropodicidal gel bait composition 10 and ingests a sample. Arthropodicidal gel bait composition 10 includes an attractant, which can be a phagostimulant. A phagostimulant stimulates the foraging arthropod to ingest arthropodicidal gel bait composition 10 and, in the case of social arthropods, such as ants, recruit more foragers. As a result of the sampling of arthropodicidal gel bait composition 10, with its low concentration of toxin and phagostimulatory effect, foraging arthropod 30 will recruit more foragers from its home nest. As the foragers feed off of arthropodicidal gel bait composition 10, they too ingest the toxin. The foragers then return to the nest or hive and regurgitate or otherwise pass arthropodicidal gel bait composition 10 to other nest mates as sustenance. This feeding process, in combination with the low concentration of the toxin in arthropodicidal gel bait composition 10, permits more of the toxin to pass to more arthropod pests, since the foragers do not expire rapidly.

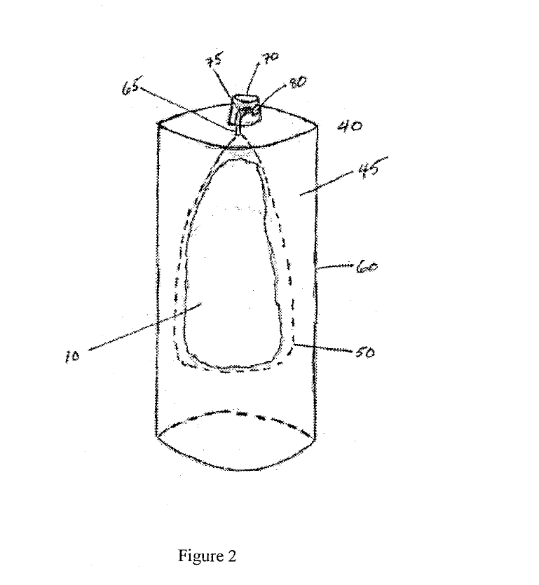

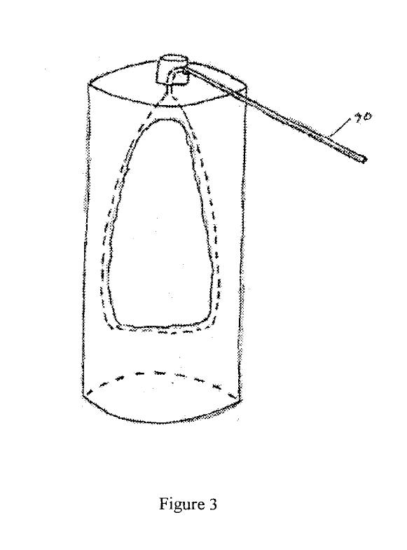

In use, as illustrated in FIGS. 2 and 3, arthropodicidal gel bait composition 10 is stored in a container 40 within a bladder 50. Container 40 has walls 60 that can withstand high pressures. Bladder 50 attaches to container 40 at tube 65 to permit arthropodicidal gel bait composition 10 to flow out of bladder 50 through cap port 75 of cap 70 and to the environment through orifice 80. Container 40 has inner space 45 that is filled with a substantially inert gas to a high pressure. The high internal pressure of container 40 places an equal pressure on bladder 50, so that once cap 70 is depressed the pressure differential between the contents of the bladder, i.e., arthropodicidal gel bait composition 10, and the outside environment forces arthropodicidal gel bait composition 10 to be expelled. Preferably, the pressure of inner space 45 is sufficiently high so as to allow arthropodicidal gel bait composition 10 to be expelled to a great distance. This ability would alleviate the user of the need for a ladder or other device to accommodate placement of arthropodicidal gel bait composition 10 in cumbersome locations.

Additionally, as illustrated in FIG. 3, container 40 can include a tip tube 90 to facilitate precision placement of arthropodicidal gel bait composition 10. This would accommodate uses in cracks or crevices, or to apply a fine line of arthropodicidal gel bait composition 10.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

That which is claimed is:

1. An arthropodicidal bait composition, comprising: a gelatinous matrix material;
an arthropod attractant dispersed in said gelatinous matrix material; and
an arthropodicide dispersed in said gelatinous matrix material.

2. An arthropodicidal bait composition of claim 1, wherein the arthropodicide is boric acid or a salt or hydrate thereof.

3. An anthropodicidal bait composition of claim 1, wherein the arthropodicide is disodium octoborate tetrahydrate.

4. The anthropodicidal bait composition as claimed in claim 1 wherein the arthropodicide is a hydroscopic insecticide.

5. An insecticidal bait composition, comprising:
a transparent gelatinous matrix material;
an insect attractant dispersed in said transparent gelatinous matrix material; and
an effective amount of disodium octoborate tetrahydrate dispersed in said transparent gelatinous matrix material.

6. The insecticidal bait composition as claimed in claim 5 wherein said transparent gelatinous matrix material is a non-toxic material.

7. The insecticidal bait composition as claimed in claim 5 wherein said insect attractant is a sugar.

8. The insecticidal bait composition as claimed in claim 5 wherein said insect attractant is a protein.

9. The insecticidal bait composition as claimed in claim 5 wherein said insect attractant is cellulose.

10. The insecticidal bait composition as claimed in claim 5 wherein said disodium octoborate tetrahydrate is 0.001 to 5 percent by weight.

11. The insecticidal bait composition as claimed in claim 5 wherein said composition is dispensed via a pressurized bladder.

12. A method for reducing an arthropod population, said method comprising the steps of:
placing a transparent gelatinous matrix material having an arthropod attractant and a hydroscopic arthropodicide dispersed in said transparent gelatinous matrix material under pressure in a container;
dispensing said transparent gelatinous matrix material from said container, and depositing said transparent gelatinous matrix material on a substrate.
